(19) United States
(12) Patent Application Publication
(10) Pub. No.: US 2026/0079131 A1
(43) Pub. Date: Mar. 19, 2026

(54) DUAL ENCODER SCANNER AND RELATED OPERATOR INTERFACE

(71) Applicant: Evident Canada, Inc., Québec (CA)

(72) Inventors: Veronique Simard, Quebec (CA); Simon Alain, Quebec (CA); Jean-Sébastien Néron, Saint-Augustin-de-Desmaures (CA)

(21) Appl. No.: 19/108,657

(22) PCT Filed: Sep. 22, 2023
(86) PCT No.: PCT/CA2023/051256

§ 371 Date: Mar. 4, 2025

Related U.S. Application Data
(60) Provisional application No. 63/376,839, filed on Sep. 23, 2022.

(51) Int. Cl. G01N 29/265; G01N 29/06; G01N 29/22

(52) U.S. Cl. CPC G01N 29/265; G01N 29/0645; G01N 29/225

(57) ABSTRACT

A non-destructive test apparatus can include a scanner assembly configured to encode movement in, for example, one or two directions. The scanner assembly comprising a carriage comprising one or more respective wheels oriented to rotate in a circumferential scan direction, the carriage housing or otherwise guiding a transducer probe assembly. A first encoder can be configured to generate a first signal representative of displacement of the carriage in the first direction, and the scanner assembly can also include 2024/059948 at least one wheel can be oriented to rotate in an indexing direction, where a second encoder is configured to generate a second signal representative of displacement of the carriage in the second direction in response to rotation of the at least one wheel oriented to rotate in second direction. An operator interface on-board the scanner assembly can receive user input and contemporaneously present a status indication to guide inspection.

### CLAIM OF PRIORITY

This patent application claims the benefit of priority of Veronique Simard et al., U.S. Provisional Patent Application Number 63/376,839, titled “DUAL ENCODER SCANNER AND RELATED OPERATOR INTERFACE,” filed on Sep. 23, 2022 (Attorney Docket No. 6409.236PRV), which is hereby incorporated by reference herein in its entirety.

### FIELD OF THE DISCLOSURE

This document pertains generally, but not by way of limitation, to apparatus and techniques for non-destructive inspection such as facilitating non-destructive inspection, such as acoustic inspection, and more particularly, to apparatus and techniques for performing encoding of scan position, such as optionally including visual feedback to an operator.

### BACKGROUND

Non-destructive testing (NDT) can refer to use of one or more different techniques to inspect regions on or within an object, such as to ascertain whether flaws or defects exist, or to otherwise characterize the object being inspected. Examples of non-destructive test approaches can include use of an eddy-current testing approach where electromagnetic energy is applied to the object and resulting induced currents on or within the object are detected, with the values of a detected current (or a related impedance) providing an indication of the structure of the object under test, such as to indicate a presence of a crack, void, porosity, or other inhomogeneity.

Another approach for NDT can include use of an acoustic inspection technique, such as where one or more electroacoustic transducers are used to insonify a region on or within the object under test, and acoustic energy that is scattered or reflected can be detected and processed. Such scattered or reflected energy can be referred to as an acoustic echo signal. Generally, such an acoustic inspection scheme involves use of acoustic frequencies in an ultrasonic range of frequencies, such as including pulses having energy in a specified range that can include value from, for example, a few hundred kilohertz, to tens of megahertz, as an illustrative example.

### SUMMARY OF THE DISCLOSURE

Non-destructive inspection can be performed using a variety of modalities. For example, as mentioned above, acoustic inspection is a non-destructive test (NDT) approach that can be used to evaluate structures such as pipes, vessels, plates, or welds related thereto, as illustrative examples. Such evaluation can include thickness gauging, corrosion monitoring, or inspection for defects such as voids or porosities in weld structures. A scanning approach can include use of a phased-array ultrasound transducer assembly. Generally, to achieve desired coverage without gaps or unusable acquisition, an approach can include manually placing a test probe assembly in an index location along the object under test, and then manually rolling or sliding the test probe assembly in a scan direction to perform a scan (e.g., to acquire respective A-scans or compile a C-scan view, as illustrative examples). After a “line” scan is completed, the test probe assembly can be moved to a new index location (e.g., “indexed”) and another scan can be performed. In such an approach, which can be referred to as raster scanning, a composite can be assembled of respective circumferential scans. In applications involving scanning of round or tubular structures such as pipes or vessels, the line scans can be circumferential, and the index direction can be axial, but the apparatus and techniques described herein are not limited to such an acquisition configuration.

Generally, the test probe assembly is coupled using an umbilical cable to a separate test instrument having a display and key inputs (or touchscreen, as an illustration). Accordingly, an operator of the test probe assembly may need to look at the separate test instrument while performing the scan, taking the operator's view away from the test probe assembly. Moreover, alignment of the test probe in such a setup may involve either using an entirely separate position encoder, manually marking index locations, or performing sometimes non-intuitive arithmetic calculations for each index step.

As an illustration, corrosion mapping of an area using acoustic inspection can be performed using one encoded axis (“clicker mode”), and such a scheme generally involves drawing lines drawn on a surface to be inspected. A position increment in a second axis is performed by displacing the probe assembly each time that the probe assembly is indexed, such as to perform another line scan parallel to the previous one but offset in the second axis. Drawing or scribing lines on the parts is complicated and can be quite time consuming. When assuming fixed increments in the instrument for each scan, the positioning of the probe assembly is done according to such fixed increments which can affect the flexibility of the inspection. For example, if an obstruction prevents indexing the scanner to the predefined increment value, the scan of the remaining surface at that index location may be precluded because the data will not be aligned correctly with the prior line scan data.

The present inventors have also recognized, among other things, that including an operator interface that can be mated with a scanner assembly housing or otherwise guiding the transducer probe assembly can facilitate non-destructive inspection data acquisition using single-axis or dual-axis encoding, with a user input device and display provided on the scanner assembly. In this manner, the operator can maintain his or her view of the scanner assembly without requiring monitoring of a display on a separate acoustic inspection instrument. As shown and described herein, the operator can also use the user input (such as a button) to select between, for example, scan (e.g., line) and indexing modes. A display can provide feedback contemporaneously, such as indicating readiness to perform a scan, or to indicate that such an acquisition has reached a specified boundary.

The present inventors have also recognized, among other things, that using a second encoder (to support a raster scan mode) can provide additional flexibility, such as enabling feedback to be given concerning an indexing operation, or to support a free-hand acquisition where movement can occur in both the scan and indexing directions during a respective acquisition. As an illustration, in the absence of an operator interface on-board the scanner assembly, an operator may need to look at a second axis value on a separate display on an acquisition instrument (separate from the scanner assembly) and try to get it as close as possible to the optimum value before doing the next line scan. For example, in an acoustic inspection application, if the ultrasound probe effective beam is 63 millimeters wide, index positions can be non-intuitive values: 63, 126, 189, 252, 315 mm, and so on. As mentioned above, it is inconvenient for the operator to look at a separate acquisition instrument each time indexing in the second axis occurs, and to perform the calculation of the next index position value if not displayed. To address such challenges, the operator interface onboard or otherwise fixed to the scanner assembly can be used to provide feedback, using the second encoder. In this manner, the user can be provided with pertinent information to perform scanning or indexing operations without having to look at a separate acquisition instrument, to perform mental calculations, or to mark the object under test.

In an example, a non-destructive test apparatus can include a scanner assembly, the scanner assembly comprising a carriage comprising at least one wheel oriented to rotate in a first direction, the carriage configured to mechanically guide a transducer probe assembly, a first encoder configured to generate a first signal representative of displacement of the carriage in the first direction in response to rotation of the at least one wheel oriented to rotate in the first direction, and an operator interface comprising a user input device and a display, the operator interface comprising a modular assembly that is removably mated with the carriage, the operator interface configured to receive an input at the user input device to control a mode of operation associated with a non-destructive inspection, and present a status indication associated with a scan operation of the non-destructive inspection. In an example, a technique such as a method can include facilitating non-destructive testing (NDT), the method comprising receiving an input at a user input device of an operator interface to control a mode of operation associated with a non-destructive inspection, in response, initiating acquisition of non-destructive inspection data associated with a scan operation of the non-destructive inspection, and presenting a status indication using a display of the operator interface, the status indication associated with the scan operation of the non-destructive inspection using displacement data acquired using a first encoder, where the user input device and the display are included as a portion of an operator interface on a scanner assembly, the scanner assembly comprising a carriage comprising at least one wheel oriented to rotate in a first direction, the carriage configured to mechanically guide a transducer probe assembly, the first encoder, configured to generate a first signal representative of displacement of the carriage in the first direction in response to rotation of the at least one wheel oriented to rotate in the first direction, and the operator interface comprising the user input device and the display.

In such examples, the scanner assembly can include at least one wheel oriented to rotate in second direction orthogonal to a first direction, and a second encoder configured to generate a second signal representative of displacement of the carriage in the second direction in response to rotation of the at least one wheel oriented to rotate in second direction, the second direction orthogonal to the first direction.

In an example, a non-destructive test apparatus can include a scanner assembly configured to encode movement in at least two directions, the scanner assembly comprising, a carriage comprising respective wheels oriented to rotate in a first direction comprising a circumferential scan direction, the carriage guiding a transducer probe assembly, a first encoder configured to generate a first signal representative of displacement of the carriage in the first direction, at least one wheel oriented to rotate in second direction orthogonal to a first direction, the second direction comprising an indexing direction along an object under test, a second encoder configured to generate a second signal representative of displacement of the carriage in the second direction in response to rotation of the at least one wheel oriented to rotate in second direction, an operator interface comprising a user input device and a display, the operator interface configured to receive an input at the user input device to control a mode of operation associated with a non-destructive inspection, and present a status indication using the display and using displacement data acquired using the first encoder or the second encoder depending on the mode of operation.

Other aspects of the scanner assembly described herein can include a local immersion configuration, such as providing a couplant chamber (e.g., water box) and beveled or radiused gasket arrangement to couple an active surface of an acoustic transducer probe array to the object under test. A modular configuration can be provided, such as can include the operator interface and second encoder as a removable (e.g., detachable) assembly that can be fixed to a carriage comprising the first encoder. Different acoustic inspection probe arrays can be removably housed by the carriage or otherwise guided by the carriage.

This summary is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally an example comprising an acoustic inspection system, such as can be used to perform at least a portion one or more techniques as shown and described herein.

FIG. 2A, FIG. 2B, and FIG. 2C illustrate generally respective views of a scanner assembly that can house an acoustic transducer probe assembly.

FIG. 3A, FIG. 3B, and FIG. 3C illustrate generally respective views of an encoder wheel handling portion of the scanner assembly.

FIG. 4 illustrates an exploded view of an acoustic transducer probe assembly, such as can include a beveled gasket.

FIG. 5 illustrates generally a technique, such as a machine-implemented method, that can include receiving an input from a user or presenting a status indication, or combinations thereof, at an operator interface located on a scanner assembly.

FIG. 6A illustrates generally an illustrative example of an operator interface, such as can be included as a portion of the scanner assembly discussed above in relation to FIG. 2A, FIG. 2B, FIG. 2C, FIG. 3A, FIG. 3B, or FIG. 3C, and such as can be used to perform the technique of FIG. 5, or other operations such as discussed in relation to the illustrative example of FIG. 6B.

FIG. 7 illustrates generally a scanner assembly located on an object under test, and a non-destructive test instrument, such as communicatively coupled with the scanner assembly.

FIG. 8 illustrates a block diagram of an example comprising a machine upon which any one or more of the techniques (e.g., methodologies) discussed herein may be performed.

### DETAILED DESCRIPTION

As discussed generally above and described in detail below, a non-destructive test apparatus can include a scanner assembly configured to encode movement in, for example, one or two directions. The scanner assembly can include a carriage comprising one or more respective wheels oriented to rotate in a circumferential scan direction, the carriage housing or otherwise guiding a transducer probe assembly. A first encoder can be configured to generate a first signal representative of displacement of the carriage in the first direction, and the scanner assembly can also include at least one wheel that is oriented to rotate in an indexing direction, where a second encoder is configured to generate a second signal representative of displacement of the carriage in the second direction in response to rotation of the at least one wheel oriented to rotate in second direction. An operator interface on-board or otherwise mechanically fixed to the scanner assembly can receive user input and contemporaneously present a status indication to guide inspection. Such an approach can help provide a “heads down” configuration to allow a user such as an inspection technician to focus his or her attention on the scanner assembly without requiring observation of index position or acquisition status on a separate test instrument during acquisition or indexing. Such an approach can also facilitate selection or use of other operational modes such as a free-hand mode of acquisition.

Generally, as shown in the examples below, a first encoder (e.g., “scan” encoder) can track a movement of the scanner in a scan direction as the scanner assembly is moved across a surface of the object under test. This movement can be interpreted by a separate acquisition instrument and converted into position data in the scan direction. Separately, a second encoder (e.g., an “index” encoder) can track a movement in a direction orthogonal to the scan direction. This movement can be interpreted by the separate acquisition instrument and converted into position data in the index direction (e.g., orthogonal to the scan direction). With the scan and index position information, the instrument can display a 2D mapping of the data acquired during the inspection, such as for performing thickness or corrosion inspection using a phased-array ultrasonic transducer (PAUT) probe assembly housed or otherwise guided by a carriage of the scanner assembly or using another non-destructive inspection technique such as eddy current inspection.

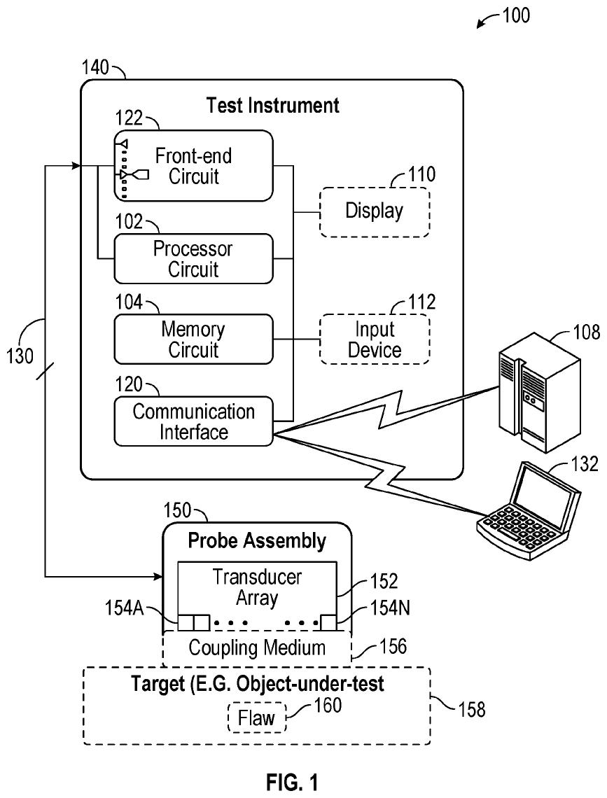

FIG. 1 illustrates generally an example comprising an inspection system 100, such as can be used to perform at least a portion one or more techniques as shown and described herein. The inspection system 100 can include a test instrument 140, such as a hand-held or portable assembly. The test instrument 140 can be electrically coupled to a probe assembly 150, such as using a multi-conductor interconnect 130. In the context of acoustic inspection, the probe assembly 150 can include one or more electroacoustic transducers, such as a transducer array 152 including respective transducers 154A through 154N. The transducers array can follow a linear or curved contour or can include an array of elements extending in two axes, such as providing a matrix of transducer elements. Element size and pitch can be varied according to the inspection application.

A modular probe assembly 150 configuration can be used, such as to allow a test instrument 140 to be used with various different probe assemblies. Generally, the transducer array 152 includes piezoelectric transducers, such as can be acoustically coupled to a target 158 (e.g., a test specimen or “object-under-test”) through a coupling medium 156. The coupling medium can include a fluid or gel or a solid membrane (e.g., an elastomer or other polymer material), or a combination of fluid, gel, or solid structures. For example, an acoustic transducer assembly can include a transducer array coupled to a wedge structure comprising a rigid thermoset polymer having known acoustic propagation characteristics (for example, Rexolite® available from C-Lec Plastics Inc.), and water can be injected between the wedge and the structure under test as a coupling medium 156 during testing, or testing can be conducted with an interface between the probe assembly 150 and the target 158 otherwise immersed in a coupling medium.

The test instrument 140 can include digital and analog circuitry, such as a front-end circuit 122 including one or more transmit signal chains, receive signal chains, or switching circuitry (e.g., transmit/receive switching circuitry). The transmit signal chain can include amplifier and filter circuitry, such as to provide transmit pulses for delivery through an interconnect 130 to a probe assembly 150 for insonification of the target 158, such as to image or otherwise detect a flaw 160 on or within the target 158 structure by receiving scattered or reflected acoustic energy elicited in response to the insonification. While FIG. 1 shows a single probe assembly 150 and a single transducer array 152, other configurations can be used, such as multiple probe assemblies connected to a single test instrument 140, or multiple transducer arrays 152 used with a single probe assembly 150 or multiple probe assemblies for pitch/catch inspection modes. Similarly, a test protocol can be performed using coordination between multiple test instruments 140, such as in response to an overall test scheme established from a master test instrument 140 or established by another remote system such as a compute facility 108 or general-purpose computing device such as a laptop 132, tablet, smart-phone, desktop computer, or the like. The test scheme may be established according to a published standard or regulatory requirement and may be performed upon initial fabrication or on a recurring basis for ongoing surveillance, as illustrative examples.

The receive signal chain of the front-end circuit 122 can include one or more filters or amplifier circuits, along with an analog-to-digital conversion facility, such as to digitize echo signals received using the probe assembly 150. Digitization can be performed coherently, such as to provide multiple channels of digitized data aligned or referenced to each other in time or phase. The front-end circuit can be coupled to and controlled by one or more processor circuits, such as a processor circuit 102 included as a portion of the test instrument 140. The processor circuit can be coupled to a memory circuit 104, such as to execute instructions that cause the test instrument 140 to perform one or more of acoustic transmission, acoustic acquisition, processing, or storage of data relating to an acoustic inspection, or to otherwise perform techniques as shown and described herein. The test instrument 140 can be communicatively coupled to other portions of the system 100, such as using a wired or wireless communication interface 120.

For example, performance of one or more techniques as shown and described herein can be accomplished on-board the test instrument 140 or using other processing or storage facilities such as using a compute facility 108 or a general-purpose computing device such as a laptop 132, tablet, smart-phone, desktop computer, or the like. For example, processing tasks that would be undesirably slow if performed on-board the test instrument 140 or beyond the capabilities of the test instrument 140 can be performed remotely (e.g., on a separate system), such as in response to a request from the test instrument 140. Similarly, storage of imaging data or intermediate data such as A-scan matrices of time-series data or other representations of such data, for example, can be accomplished using remote facilities communicatively coupled to the test instrument 140. The test instrument can include a display 110, such as for presentation of configuration information or results, and an input device 112 such as including one or more of a keyboard, trackball, function keys or soft keys, mouse-interface, touch-screen, stylus, or the like, for receiving operator commands, configuration information, or responses to queries.

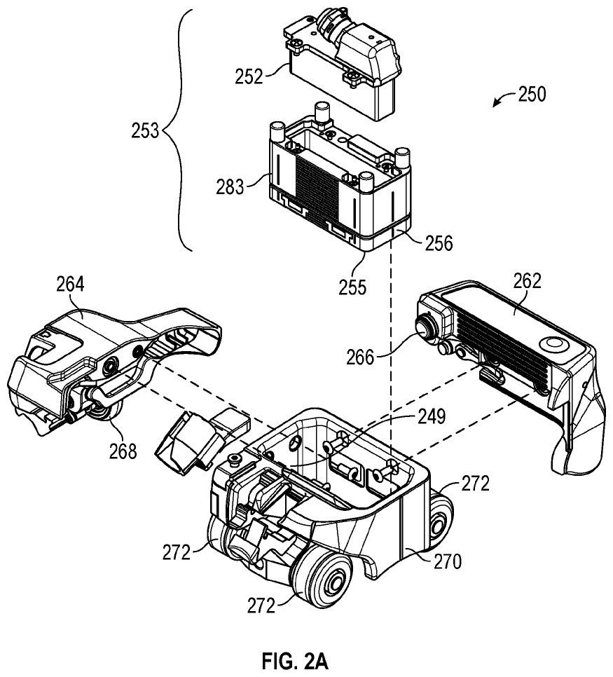

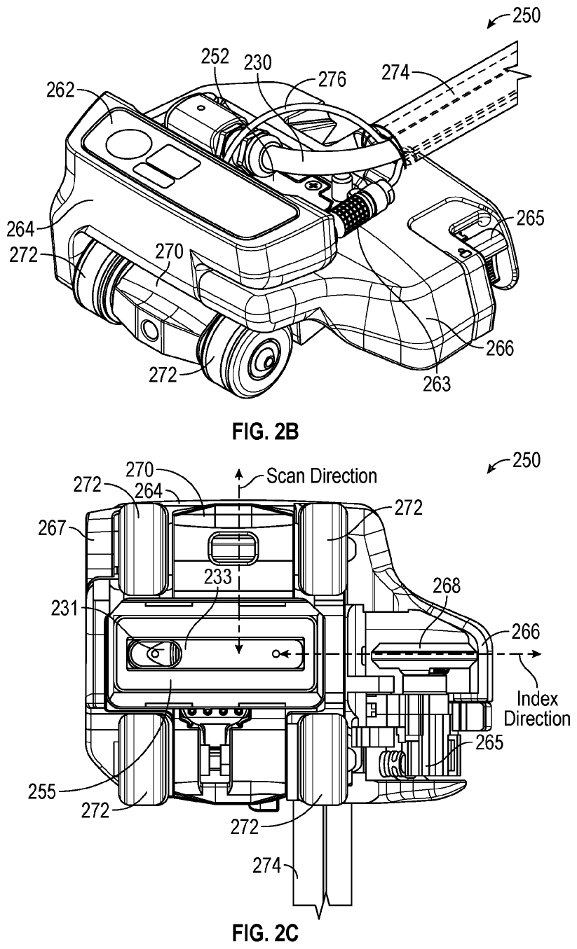

FIG. 2A, FIG. 2B, and FIG. 2C illustrate generally respective views of a scanner assembly 250 that can house an acoustic transducer probe assembly 253. As shown in FIG. 2A, FIG. 2B, and FIG. 2C, the scanner assembly 250 can be modular, such as allowing use of different acoustic transducer probe assembly 253 configurations (e.g., such as support an acoustic transducer array 252 having a specified count of acoustic transducer elements such as defining a specified aperture width or having other specified characteristics). The transducer array 252 can be communicatively coupled with an analog front end on a separate acoustic inspection instrument, such as through a cable 230. The acoustic probe assembly can include a gasket support frame 256 and housing such as to provide a couplant chamber (e.g., water box 283) and to support a gasket (such as including a cover 255) to provide local immersion of an interface between an object under test and an active surface 233 of the acoustic transducer array 252. For example, the gasket can be configured to retain couplant in the region between a surface of the object under test and the active surface 233. The couplant chamber can be supplied through a couplant aperture 231, such as fed by a couplant line 276.

The scanner assembly 250 can include a carriage 270 such as defining or otherwise including a region 249 to receive the acoustic transducer probe assembly 253 to mechanically house the acoustic transducer probe assembly 253. Other configurations can be used, such as an arrangement where one or more acoustic transducer probe assemblies are mechanically anchored to a carriage, such as via arms or a support frame. The carriage 270 can include wheels 272 aligned to rotate in a first direction (e.g., defining a scan axis for acquiring a line scan). A line scan direction can be circumferential around a cylindrical or tubular object under test, longitudinally for an axial scan alignment, or aligned in another direction, such as a specified direction along a planar object under test. The wheels 272 can be magnetized or can contain a permanent magnet so that the carriage 270 is held against a ferromagnetic object under test during scanning. As shown in FIG. 2A, FIG. 2B, and FIG. 2C, an operator interface 262 can be removably mated with the carriage 270. For example, the operator interface 262 can include one or more user inputs and a display, as shown and described below in other examples. The operator interface 262 can be custom-manufactured for the scanner assembly 250, or the operator interface 262 can be or can include an off-the-shelf assembly such as a mobile device or tablet device having a touch-screen or other user input device and a display, such as mechanically fixed to the carriage 270 by a mount or otherwise mechanically coupled with the carriage 270. The operator interface 262 can house or otherwise include one or more encoders, such as a first encoder 267 that can monitor rotation of one or more of the wheels 272, forming a scan encoder assembly 264. The operator interface can include an electrical connector 263 or other provision for communication and power, such as for interconnection via a cable and connector 263 with a separate acoustic inspection instrument. One or more of the couplant line 276, the cable 230, or a cable coupled with the connector 263 can be bundled together can held within a cable loom or umbilical bundle 274.

The scanner assembly 250 can include a second wheel 268, such as configured to rotate in a second direction orthogonal to a direction of rotation of the wheels 272. Such a direction can be an index direction along the object under test. For example, as shown in the illustration of FIG. 2A, an index encoder assembly 266 can house a second encoder that can monitor rotation of the second wheel 268. The first wheels 272 and the second wheel 268 can be configured to rotate exclusively in their respective directions (e.g., the first wheels 272 rotate for movement along the first direction and the second wheel 268 rotates for movement along the orthogonal second direction).

As shown and described below, the operator interface 262 can provide an indication to a user, such as a status indication indicative of whether a first encoder, a second encoder, or both are active, or otherwise indicating an active operational mode of the scanner assembly 250. As shown in FIG. 2B and FIG. 2C, the index encoder assembly 266 can include a stow lever 265, such as to raise or lower the second wheel 268. The second wheel 268 can also include other features such as to limit binding or facilitate sliding in the circumferential direction. For example, as shown in FIG. 2A, FIG. 2B., and FIG. 2C, the second wheel 268 can be beveled, or radiused.

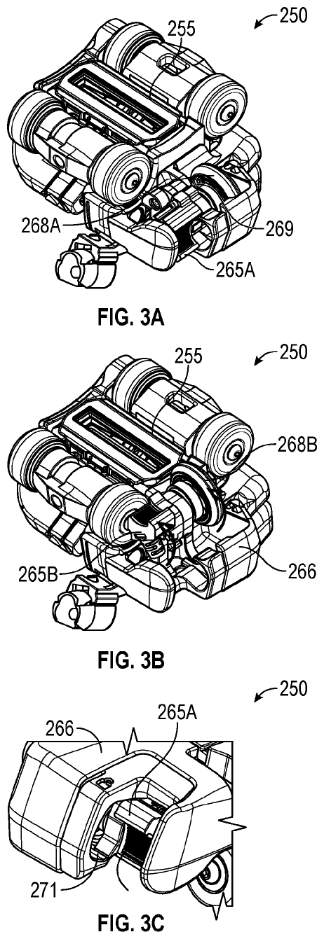

As an illustration of the stow lever 265 operation and other features that can be included as a portion of the index encoder assembly 266, FIG. 3A, FIG. 3B, and FIG. 3C illustrate generally respective views of an encoder wheel handling portion of the scanner assembly 250, such as can be included as part of the index encoder assembly 266. In FIG. 3A, the second wheel can be in a raised or disengaged position 268A, such as in response to the stow control being in a raised position 265A. In this raised position 268A, the second wheel can avoid causing binding or off-axis displacement of the carriage when the carriage is moving orthogonally (or substantially orthogonally) to a direction of rotation of the second wheel. As shown in FIG. 3A, a resistance or friction associated with rotation of the second wheel can be adjusted such as using a resistance control 269 (where such a control can impart a force or select application of a force to a shaft or hub of the second wheel. In FIG. 3B the second wheel can be moved to a lowered or engaged position 268B, such as by moving the stow control to a lowered position 265B. FIG. 3C shows a locking configuration of the stow lever of index encoder assembly 266 of the scanner assembly 250, where in the raised position 268A, the stow lever can engage a clip, tab, or other retention feature 271 that can engage the stow lever and prevent the stow lever from lowering unless the stow lever is pressed inward.

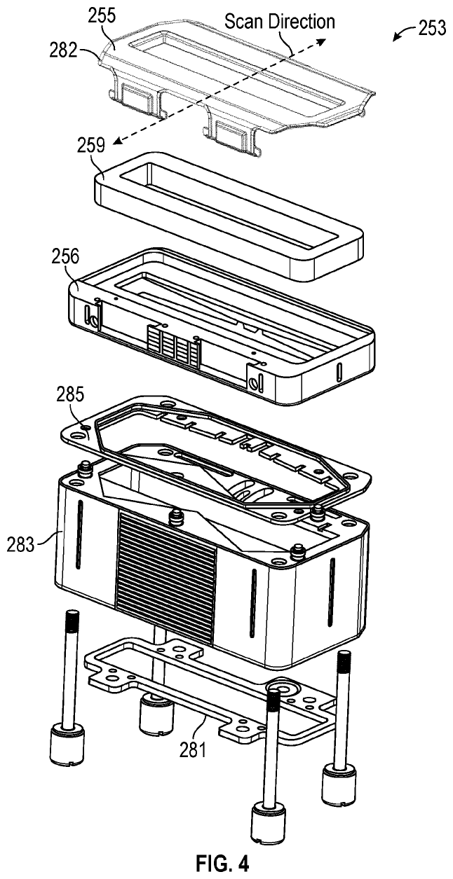

FIG. 3A and FIG. 3B also show an end view of a gasket cover 255 and features of the gasket cover 255 are discussed with respect to FIG. 4, which illustrates an exploded view of an acoustic transducer probe assembly 253 (where the acoustic transducer array 252 itself is not shown), such as can include the gasket cover 255. The gasket cover 255 can be a replaceable element made of either porous (e.g., moisture absorbing) or non-porous material, and can include or define respective beveled or radiused edges, such as a beveled edge 282 to suppress one or more of binding of, pinching of, or damage to a flexible gasket 259, such as when the acoustic transducer probe assembly 253 is moved in the scan direction (as compared to the indexing direction). The gasket 259 and gasket cover 255 can help to maintain couplant within a couplant chamber defined by an interior of a transducer housing water box 283 and gasket support frame 256. The acoustic transducer probe assembly 253 can include other elements such as plates 281 and 285, with the assembled acoustic transducer probe assembly 253 being configured to provide local immersion by couplant of a surface of the object under test.

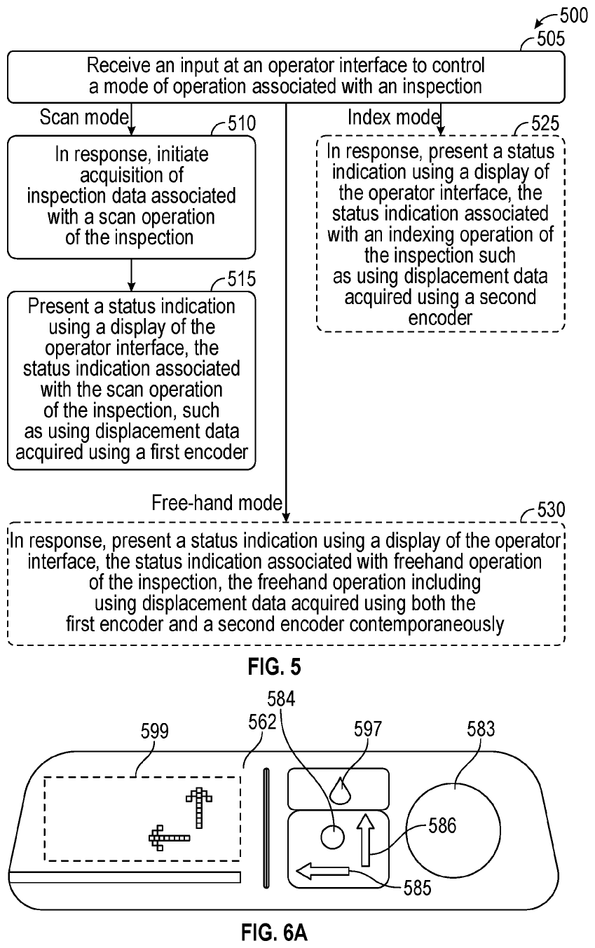

FIG. 5 illustrates generally a technique 500, such as a machine-implemented method, that can include receiving an input from a user or presenting a status indication, or combinations thereof, at an operator interface located on a scanner assembly. The technique 500 can be implemented in software or firmware instructions, such as executed by one or more processors locally on-board a scanner assembly, or in cooperation with another device such as an acoustic test instrument having one or more processors. At 505, the operator interface of the scanner assembly can receive an input (such as a press of a button or input provided to a touch-screen provided by a user). Such an input can control a mode of operation associated with an acoustic inspection. For example, such an input is used to select a scanning operational mode, such as indicating a beginning of a line scan operation in a first direction. At 510, in the scanning operational mode, in response to the user input, acquisition can be initiated of acoustic inspection data associated with the scan operation.

At 515, such as contemporaneously with initiating acquisition or during acquisition, a status indication can be provided using the display. The display can include a light emitter (e.g., light emitting diode or other lamp) or display element that illuminates (e.g., varies in brightness) or shows a specified color (e.g., green) to indicate that acquisition is active in the scanning operational mode. Such a status indication can indicate that scanning in the first direction should be initiated or should continue, or that scanning should terminate. For example, the display can be updated, or a status indication can otherwise be provided using displacement data acquired using a first encoder, the first encoder representative of displacement of the scanner assembly in the first direction. For example, the light emitting device can shift from green to red, can flash, or can be extinguished when a boundary defining specified coverage for a respective line scan is encountered or breached. For example, if the scanner assembly is moved beyond a line scan boundary, the light emitting device can shift from green to flashing green, or from green to red.

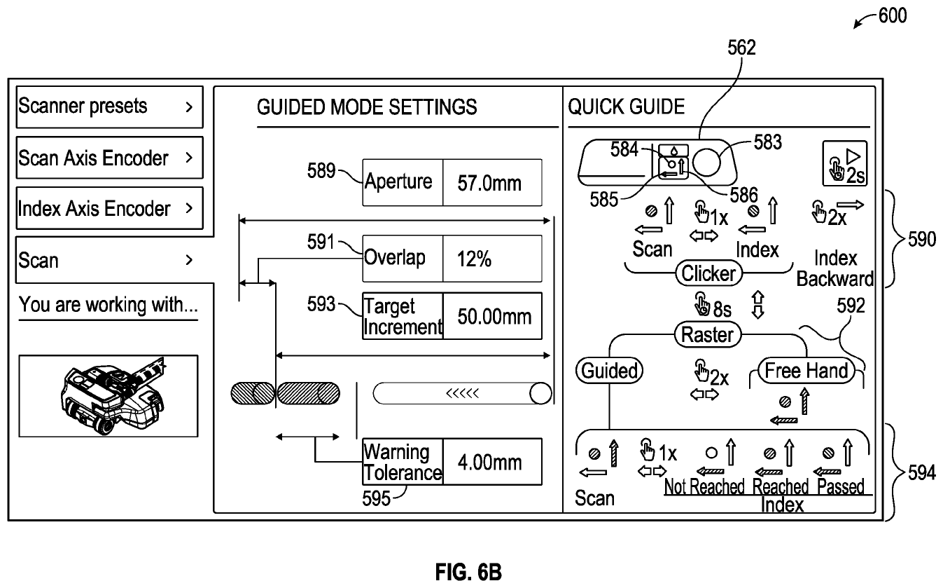

In another example, input received at 505 can toggle or otherwise select an indexing operational mode from amongst other operational modes. The operator interface can, at 525, in response to selection of an indexing operational mode, present a status indication associated with an indexing operation. For example, such a status indication can provide contemporaneous feedback to the user using displacement data acquired using a second encoder that is configured to encode displacement in a direction orthogonal to the first encoder. Examples of such a status indication are discussed further below in relation to the illustrative (but non-limiting) examples of FIG. 6A and FIG. 6B. As an illustration, the status indicator can change brightness or color to indicate that movement in a second (e.g., indexing) direction should be initiated or should continue to achieve a specified index location. The status indicator can change to indicate that movement in the indexing direction should terminate, or even that the scanner has overshot the specified index location (or is outside a specified margin from such a location). The scanning operational mode and indexing operational modes can generally be referred to as examples supporting a raster scan, where respective line scans can be performed at different index locations to assemble a composite, and where encoding is performed in both the scan direction and an orthogonal indexing direction (e.g., a “dual” encoding approach). The operator interface can also support selection of a free-hand operational mode, such as at 530, presenting a status indication using a display of the operator interface indicative that a free-hand operational mode is active, the free-hand operational mode including using displacement data acquired using both the first encoder and the second encoder contemporaneously.

FIG. 6A illustrates generally an illustrative example of an operator interface 562, such as can be included as a portion of the scanner assembly discussed above in relation to FIG. 2A, FIG. 2B, FIG. 2C, FIG. 3A, FIG. 3B, or FIG. 3C, and such as can be used to perform the technique of FIG. 5, or other operations such as discussed elsewhere herein, such as in relation to the illustrative example of FIG. 6B. The operator interface 562 as shown in FIG. 6A and FIG. 6B can include a user input device such as a momentary-contact button 583, keypad, touch-screen, or other input. The operator interface 562 can include a display, such as comprising light-emitting devices, such as a status indicator 584 or couplant condition indicator 597, or other display elements (e.g., index guide 585 and scan guide 586 indicators, pixel elements or icons such as presented using a bit-field or liquid-crystal display such as a graphical display 599). As mentioned elsewhere herein, the operator interface 562 need not be custom or scanner-specific and can be realized on a mobile or tablet device, such as fixed to scanner assembly.

In examples herein, a status indication can be presented using one or more purpose-specific indicators or annunciators or using a general-purpose (e.g., bit-field display). Referring to FIG. 6B, the scanner assembly and its associated operator interface 562 can be used to implement a variety of different scan configurations or workflows. For example, a user-interface 600 can be presented by another device or system, such as a non-destructive test instrument used for configuring an acoustic inspection operation or respective acquisitions comprising such an operation. For example, a scanner assembly can be selected or detected from amongst multiple available assemblies that may be compatible with the non-destructive test instrument. Either manually or automatically, a probe aperture value 589 can be set, and an associated indexing increment value 593 can be established. For example, an indexing increment value 593 can be less than the probe aperture value 589, such as resulting in an overlap value 591 corresponding to overlap in the indexing direction between adjacent or successive line scans.

As an illustrative example, a “clicker” workflow, as explained in the user-interface 600 guide and shown in the region 590, can behave as follows: in an initial state, the workflow can start with the first encoder (e.g., scan encoder) of the scan assembly activated as indicated by the status indicator 584 being illuminated (e.g., showing a green indication with neither of the index guide 585 or scan guide 586 being lit), allowing the operator to perform a line scan. In the “clicker” workflow, when the operator clicks the button 583, the first encoder can be toggled between an active and an inactive status. When inactive, the status indicator 584 can be illuminated with a different color (e.g., red), and the operator can move the scanner assembly in an indexing direction without overwriting previously-acquired line-scan data. Once an indexing operation is performed, the operator can click the button 583, activating the scan encoder (changing the operational mode to the scanning mode), to perform the next line scan using a stored increment of the index value in the instrument. In this “clicker” mode, encoding of movement in the index or axial direction is not performed, and the index increment is generally fixed in the instrument. Other modes can be supported, such as a “reverse” indexing mode. For example, in the “clicker” workflow, a transition to a “reverse” indexing mode can be accomplished such as in response to a sequence of clicks of the button 583 (e.g., a double-click operation). In this mode, the index location can be shifted by the associated indexing increment value 593 in a direction opposite the normal index direction, such as for performing a re-scan of a prior line scan.

Another type of workflow can include a “raster” workflow, where encoding can be performed in both a scan (e.g., circumferential) direction, and an indexing (e.g., axial) direction. For example, as shown in FIG. 6B, the operator interface 562 can be used to select between “clicker” and “raster” modes, such as in response to sustained pressure by the operator on the button 583 (e.g., pressing and holding a momentary-contact pushbutton for a specified duration longer than the “click” duration mentioned above, such as about 8 seconds). In a “guided” mode shown in the region 594, a first state can include having the first (e.g., scan) encoder active, and the second (e.g., index) encoder disabled or ignored. This can be referred to as “muting” an encoder. Muting the encoder can prevent false counts from being processed by the acquisition instrument.

In the operator interface 562, the scan guide 586 and the index guide 585 can be selectively illuminated, such as indicating which encoder axis is active. The status indicator 584 can indicate a scan mode (versus an indexing mode), as in the “clicker” operational mode above. When a respective line scan at a respective index location is completed, the operator can click the button 583 to select the indexing operational mode. For example, this will mute the scan encoder and unmute the index encoder, where the scan guide 586 indicator is extinguished and the index guide 585 becomes illuminated (or other indicia can be provided). The status indicator 584 can be extinguished. In the indexing operational mode, index movement is tracked and compared to the associated indexing increment value 593. Once the index position is within a specified range of the desired value, such as a specified range selected or indicated by the warning tolerance 595 display, the status indicator 584 can change, such as becoming illuminated (e.g., showing green). If the index movement continues beyond a location corresponding to the associated indexing increment value 593, the status indicator 584 can change, such as changing color (e.g., showing red) or presenting some other indication of overshoot. In this manner, the status indicator 584 varies in response to a distance traversed by the scanner assembly. Once indexing is completed by the operator, the operator can click the button 583 to select the scanning operational mode and perform a new encoded line scan at the new index location.

Another raster operational mode can be available, shown illustratively in the region 592 as a “free-hand” mode. In the free-hand operational mode, both the index encoder and the scan encoder can be active contemporaneously. The status indicator can still provide index increment tracking (e.g., changing from unlit, to green, to red depending on movement along the index axis), but in the free-hand mode, the index encoder remains active even during line scan acquisition. As an illustrative example, toggling between free-hand and guided non-free-hand operation can be accomplished such as in response to a sequence of clicks of the button 583 (e.g., a double-click operation). Generally, indicator colors or other behavior, and user inputs as discussed above are merely illustrative examples. Other methods or devices for indication can be used in relation to the operator interface 562, such as bit-field displays, text, numeric, or icon-based indicators, touch-screen inputs, or soft-keys, as illustrative examples. Generally, the approaches and workflows mentioned above allow the user to be “heads down,” looking at the scanner assembly during acquisition or indexing (or both), without requiring the user to view a separate display on the acquisition instrument.

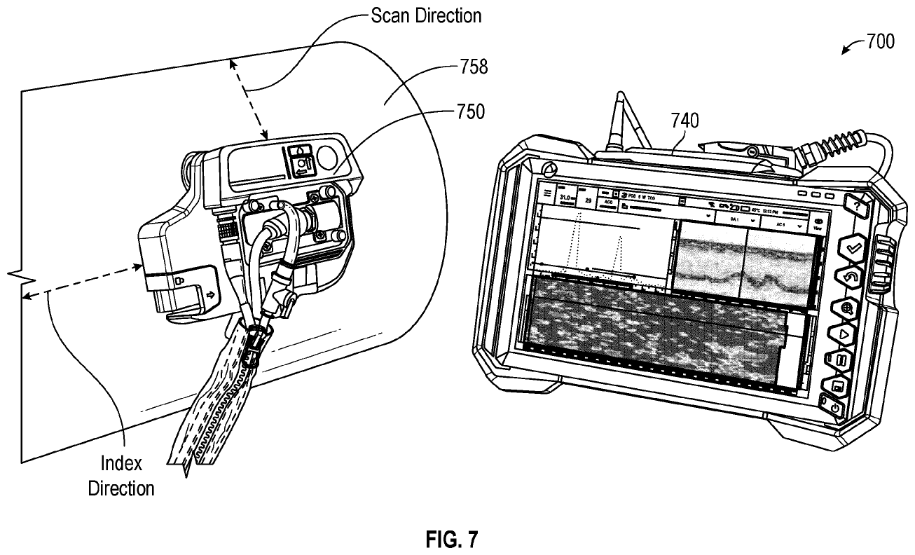

For additional context as to this distinction, FIG. 7 illustrates generally a system 700, comprising a scanner assembly 750 located on an object under test 758, and a non-destructive test instrument 740 (e.g., a separate acquisition instrument that stores the inspection data acquired by the scanner assembly 750), such as communicatively coupled with the scanner assembly 750. The workflows mentioned above can be performed using an operator interface located on-board the scanner assembly 750 without requiring the operator to view a display of the non-destructive test instrument 740 during acquisition. Various acoustic inspection parameters or other configuration can be performed using a user-interface presented by the non-destructive test instrument 740, with line scan acquisition and indexing performed using the operator interface of the scanner assembly 750 without requiring the operator to hand calculate indexing increments or view cues or values on the non-destructive test instrument 740 during indexing or line scan acquisition. Such an approach can address various challenges, such as enhancing index positioning accuracy, enhancing throughput of inspection (e.g., allowing inspection to be performed more rapidly with less setup or rework), or simplifying operation of the system 700, or combinations of such technical improvements. While FIG. 7 shows the indexing direction as an axial direction, and the scan direction as a circumferential direction, with a cylindrical object under test, the apparatus and techniques described in this document are applicable to other objects and orientations. For example, a scan direction can be longitudinal or axial, instead of circumferential. Planar objects can also be inspected using the approaches and apparatus described herein.

Many of the examples in this document refer to acoustic inspection using an acoustic transducer probe. The apparatus and techniques described herein are generally applicable to other non-destructive test modalities, such as eddy current or optical inspection, as illustrative examples.

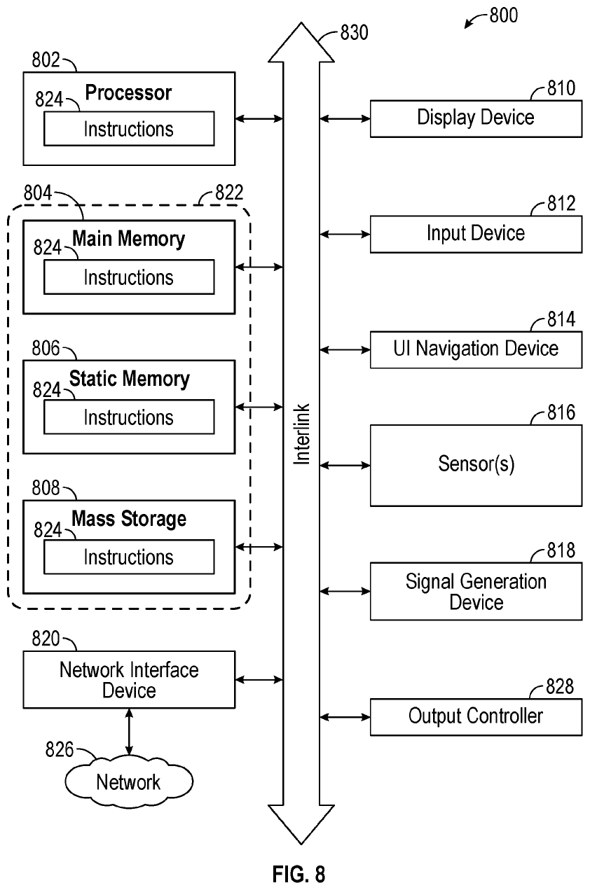

FIG. 8 illustrates a block diagram of an example comprising a machine 800 upon which any one or more of the techniques (e.g., methodologies) discussed herein may be performed. Machine 800 (e.g., computer system) may include a hardware processor 802 (e.g., a central processing unit (CPU), a graphics processing unit (GPU), a hardware processor core, or any combination thereof), a main memory 804 and a static memory 806, connected via an interlink 830 (e.g., link or bus), as some or all of these components may constitute hardware for systems or related implementations discussed above.

Specific examples of main memory 804 include Random Access Memory (RAM), and semiconductor memory devices, which may include storage locations in semiconductors such as registers. Specific examples of static memory 806 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; or optical media such as CD-ROM and DVD-ROM disks.

The machine 800 may further include a display device 810, an input device 812 (e.g., a keyboard), and a user interface (UI) navigation device 814 (e.g., a mouse). In an example, the display device 810, input device 812, and UI navigation device 814 may be a touch-screen display. The machine 800 may include a mass storage device 808 (e.g., drive unit), a signal generation device 818 (e.g., a speaker), a network interface device 820, and one or more sensors 816, such as a global positioning system (GPS) sensor, compass, accelerometer, or some other sensor. The machine 800 may include an output controller 828, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The mass storage device 808 may comprise a machine-readable medium 822 on which is stored one or more sets of data structures or instructions 824 (e.g., software) embodying or utilized by any one or more of the techniques or functions described herein. The instructions 824 may also reside, completely or at least partially, within the main memory 804, within static memory 806, or within the hardware processor 802 during execution thereof by the machine 800. In an example, one or any combination of the hardware processor 802, the main memory 804, the static memory 806, or the mass storage device 808 comprises a machine-readable medium.

Specific examples of machine-readable media include, one or more of non-volatile memory, such as semiconductor memory devices (e.g., EPROM or EEPROM) and flash memory devices; magnetic disks, such as internal hard disks and removable disks; magneto-optical disks; RAM; or optical media such as CD-ROM and DVD-ROM disks. While the machine-readable medium is illustrated as a single medium, the term “machine readable medium” may include a single medium or multiple media (e.g., a centralized or distributed database, or associated caches and servers) configured to store the one or more instructions 824.

An apparatus of the machine 800 includes one or more of a hardware processor 802 (e.g., a central processing unit (CPU), a graphics processing unit (GPU), a hardware processor core, or any combination thereof), a main memory 804 and a static memory 806, sensors 816, network interface device 820, antennas, a display device 810, an input device 812, a UI navigation device 814, a mass storage device 808, instructions 824, a signal generation device 818, or an output controller 828. The apparatus may be configured to perform one or more of the methods or operations disclosed herein.

The term “machine readable medium” includes, for example, any medium that is capable of storing, encoding, or carrying instructions for execution by the machine 800 and that cause the machine 800 to perform any one or more of the techniques of the present disclosure or causes another apparatus or system to perform any one or more of the techniques, or that is capable of storing, encoding or carrying data structures used by or associated with such instructions. Non-limiting machine-readable medium examples include solid-state memories, optical media, or magnetic media. Specific examples of machine-readable media include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); or optical media such as CD-ROM and DVD-ROM disks. In some examples, machine readable media includes non-transitory machine-readable media. In some examples, machine readable media includes machine readable media that is not a transitory propagating signal.

The instructions 824 may be transmitted or received, for example, over a communications network 826 using a transmission medium via the network interface device 820 utilizing any one of a number of transfer protocols (e.g., frame relay, internet protocol (IP), transmission control protocol (TCP), user datagram protocol (UDP), hypertext transfer protocol (HTTP), etc.). Example communication networks include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®), IEEE 802.15.4 family of standards, a Long Term Evolution (LTE) 4G or 5G family of standards, a Universal Mobile Telecommunications System (UMTS) family of standards, peer-to-peer (P2P) networks, satellite communication networks, among others.

In an example, the network interface device 820 includes one or more physical jacks (e.g., Ethernet, coaxial, or other interconnection) or one or more antennas to access the communications network 826. In an example, the network interface device 820 includes one or more antennas to wirelessly communicate using at least one of single-input multiple-output (SIMO), multiple-input multiple-output (MIMO), or multiple-input single-output (MISO) techniques. In some examples, the network interface device 820 wirelessly communicates using Multiple User MIMO techniques. The term “transmission medium” shall be taken to include any intangible medium that is capable of storing, encoding or carrying instructions for execution by the machine 800, and includes digital or analog communications signals or other intangible medium to facilitate communication of such software.

### Various Notes

Each of the non-limiting aspects above can stand on its own or can be combined in various permutations or combinations with one or more of the other aspects or other subject matter described in this document.

The above detailed description includes references to the accompanying drawings, which form a part of the detailed description. The drawings show, by way of illustration, specific embodiments in which the invention can be practiced. These embodiments are also referred to generally as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc., are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Such instructions can be read and executed by one or more processors to enable performance of operations comprising a method, for example. The instructions are in any suitable form, such as but not limited to source code, compiled code, interpreted code, executable code, static code, dynamic code, and the like. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A non-destructive test apparatus comprising:
a scanner assembly, the scanner assembly comprising:
a carriage comprising at least one wheel oriented to rotate in a first direction, the carriage configured to mechanically guide a transducer probe assembly;
a first encoder configured to generate a first signal representative of displacement of the carriage in the first direction in response to rotation of the at least one wheel oriented to rotate in the first direction; and
an operator interface comprising a user input device and a display, the operator interface comprising a modular assembly that is removably mated with the carriage, the operator interface configured to:
receive an input at the user input device to control a mode of operation associated with a non-destructive inspection; and
present a status indication associated with a scan operation of the non-destructive inspection.

2. The non-destructive test apparatus of claim 1, wherein the operator interface is configured to present using the display a status indication indicative that at least one of:
scanning in the first direction should be initiated or should continue; or
scanning should terminate.

3. The non-destructive test apparatus of claim 1, wherein the operator interface is configured to receive the input at the user input device to select the mode of operation as a scanning operational mode; and
in response, wherein the operator interface is configured to present using the display a status indication to indicate that scanning in the first direction should be initiated.

4. The non-destructive test apparatus of claim 1, wherein the scanner assembly comprises:
at least one wheel oriented to rotate in second direction orthogonal to a first direction; and
a second encoder configured to generate a second signal representative of displacement of the carriage in the second direction in response to rotation of the at least one wheel oriented to rotate in second direction, the second direction orthogonal to the first direction.

5. The non-destructive test apparatus of claim 4, wherein the second direction comprises an axial indexing direction along an object under test.

6. The non-destructive test apparatus of claim 4, wherein the operator interface is configured to receive the input at the user input device to select the mode of operation from amongst a scanning operational mode and an indexing operational mode; and
in response, wherein the operator interface is configured to present using the display a status indication showing whether a scanning operational mode or an indexing operational mode is active.

7-9. (canceled)

10. The non-destructive test apparatus of claim 4, wherein at least one of the first encoder or the second encoder is included as a portion of the modular assembly that can be removably mated with the carriage.

11-14. (canceled)

15. The non-destructive test apparatus of claim 1, wherein the first direction comprises a circumferential scan direction along an object under test.

16. The non-destructive test apparatus of claim 1, further comprising the transducer probe assembly; and
wherein the transducer probe assembly comprises a gasket, the gasket configured to retain couplant in a region between a surface of an object under test and an active surface of the transducer probe assembly; and
wherein the transducer probe assembly comprises an acoustic transducer probe assembly.

17. The non-destructive test apparatus of claim 16, wherein the gasket or a corresponding gasket protector comprises a beveled or radiused edge, the beveled or radiused edge configured to suppress binding or pinching of the gasket as the transducer probe assembly is moved along the object under test.

18. The non-destructive test apparatus of claim 16, wherein the operator interface is configured to provide an indication of status of couplant condition, the couplant condition corresponding to an interface between the acoustic transducer probe assembly and an object under test.

19. (canceled)

20. A method for facilitating non-destructive testing (NDT), the method comprising:
receiving an input at a user input device of an operator interface to control a mode of operation associated with a non-destructive inspection;
in response, initiating acquisition of non-destructive inspection data associated with a scan operation of the non-destructive inspection; and
presenting a status indication using a display of the operator interface, the status indication associated with the scan operation of the non-destructive inspection using displacement data acquired using a first encoder;
wherein the user input device and the display are included as a portion of an operator interface on a scanner assembly, the scanner assembly comprising:
a carriage comprising at least one wheel oriented to rotate in a first direction, the carriage configured to mechanically guide a transducer probe assembly;
the first encoder, configured to generate a first signal representative of displacement of the carriage in the first direction in response to rotation of the at least one wheel oriented to rotate in the first direction; and
the operator interface comprising the user input device and the display.

21-22. (canceled)

23. The method of claim 20, wherein the scanner assembly comprises:
at least one wheel oriented to rotate in second direction orthogonal to a first direction; and
a second encoder configured to generate a second signal representative of displacement of the carriage in the second direction in response to rotation of the at least one wheel oriented to rotate in second direction, the second direction orthogonal to the first direction.

24. The method of claim 23, wherein the second direction comprises an indexing direction along an object under test; and
wherein the operator interface is configured to receive the input at the user input device to select the mode of operation from amongst a scanning operational mode and an indexing operational mode; and
in response, wherein the operator interface is configured to present using the display a status indication showing whether a scanning operational mode or an indexing operational mode is active.

25-27. (canceled)

28. The method of claim 24, wherein the operator interface is configured to receive the input at the user input device to select the mode of operation from amongst the scanning operational mode, the indexing operational mode, or a free-hand operational mode where encoding is performed contemporaneously in both an indexing direction and a scan direction.

29. The method of claim 20, wherein the first direction comprises a circumferential scan direction along an object under test.

30-32. (canceled)

33. A non-destructive test apparatus comprising:
a scanner assembly configured to encode movement in at least two directions, the scanner assembly comprising:
a carriage comprising respective wheels oriented to rotate in a first direction comprising a circumferential scan direction, the carriage guiding a transducer probe assembly;
a first encoder configured to generate a first signal representative of displacement of the carriage in the first direction;
at least one wheel oriented to rotate in second direction orthogonal to a first direction, the second direction comprising an indexing direction along an object under test;
a second encoder configured to generate a second signal representative of displacement of the carriage in the second direction in response to rotation of the at least one wheel oriented to rotate in second direction;
an operator interface comprising a user input device and a display, the operator interface configured to:
receive an input at the user input device to control a mode of operation associated with a non-destructive inspection; and
present a status indication using the display and using displacement data acquired using the first encoder or the second encoder depending on the mode of operation.

34. The non-destructive test apparatus of claim 33, wherein the user input device comprises a button; and
wherein the display comprises respective indicators; and
wherein the received input at the user input device comprises one of a single click of the button, a double-click of the button, or sustained pressure on the button for a specified duration; and
in response, wherein the operator interface is configured to indicate a mode of operation in response depending on whether the user input comprises a single click, a double-click, or sustained pressure on the button.

35. The non-destructive test apparatus of claim 34, wherein the respective indicators comprise respective light emitters or respective display elements indicating whether the carriage is to be moved in the first direction, the second direction, or both directions.

36. The non-destructive test apparatus claim 34, wherein the respective indicators comprise a light emitter or display element that changes at least one of brightness or color depending on distance traversed by the carriage in either the first direction or the second direction.

37. (canceled)
